(19) United States
(12) Patent Application Publication
(10) Pub. No.: US 2008/0264195 A1
(43) Pub. Date: Oct. 30, 2008

(54) Industrial Robot

(75) Inventors: Jan Larsson, Vasteras (SE); Karl-Gunnar Johnsson, Vasteras (SE); Mars Olsson, Vasteras (SE); Bo Toresson, Koping (SE); Stig Persson, Vasteras (SE); Tommi Paananen, Vasteras (SE)

Correspondence Address: VENABLE LLP, P.O. BOX 34385, WASHINGTON, DC, 20043-9998, US

(73) Assignee: ABB AB, VASTERAS (SE)

(21) Appl. No.: 11/884,031

(22) PCT Filed: Feb. 13, 2006
(86) PCT No.: PCT/SE2006/000190

§ 371 Date: Aug. 9, 2007

(30) Foreign Application Priority Data
Feb. 11, 2005 (SE) 0500339-7

(51) Int. Cl. B25J 9/10

(52) U.S. Cl. 74/490.02; 74/490.03; 901/15; 901/23; 901/17; 901/18; 901/25

(57) ABSTRACT

An industrial robot including a drive package with a motor and a gear between an output shaft of the motor and a third shaft of the robot in immediate proximity to the third shaft for rotation of an upper arm of the robot relative to a lower arm. The gear is a multistage gear transmission with parallel gear-wheel axes and one of the gear wheels of the gear is secured to the third shaft.

### FIELD OF THE INVENTION AND BACKGROUND ART

The present invention relates to an industrial robot with a fixed base, a frame pivotally connected thereto about a first axis, a lower arm, one end of which is pivotally connected to the frame about a second axis, and an upper arm, one end of which is pivotally connected to the other end of the lower arm about a third axis.

The invention relates to industrial robots for any conceivable use, such as, for example, for welding, painting, removal of goods, etc.

“Fixed base” is to be interpreted as being fixed on the base on which the robot rests, but the latter base may very well be movable, for example be in the form of a car running on rails. Said three axes are usually in the following order: vertical, horizontal and horizontally parallel to the second one, but also other directions are feasible. With regard to the designation “horizontal” and “vertical” above and in the following description, reference is made to the case where the robot is standing on a horizontal base.

The number of axes is often six in such an industrial robot in order to achieve maximum freedom of movement for a gripping claw, spray nozzle, or the like, mounted at the outer end of the upper arm via a so-called wrist. However, the invention also includes industrial robots with fewer axes, and it is quite possible for the robot to exhibit the above-mentioned three axes only.

To be able to drive the upper arm to be rotated about said third axis relative to the lower arm, a drive package with a motor and a gear is required between the output shaft of the motor and the third axis to reduce the speed of the motor and be able to achieve precise movements of the upper arm relative to the lower arm.

In one type of industrial robots, such a drive package with a motor and a gear is arranged in the frame of the robot and the gear is connected to the upper arm via a parallel link. This means that the range for the possible oscillation of the upper arm about the third axis is relatively limited; nor can the robot be moved between standing on a floor and hanging from a roof without reconstruction.

With regard to the above-mentioned properties of the design just described, industrial robots have been produced in which a drive package with a motor and a gear between the output shaft of the motor and the third axle have been arranged in immediate proximity to the third axle. The present invention relates to an industrial robot of that type. In prior art industrial robots of this kind, a so-called compact gear was used in said drive package. Such a gear is relatively complicated and requires very high manufacturing precision. If the third axle is to be made hollow for internal cable pulling, the gear will be complicated and costly, while at the same time this type of gear requires a housing of its own outside the actual robot stand, that is, adjacent to the lower arm or the upper arm. In this type of gear, the design will be clumsy and bulky if zero offset is to be achieved between the third axis and a possible fourth axis which, if it exists, extends in the longitudinal direction of the upper arm for rotation of the upper arm, which implies that the third axis and a possible such fourth axis can only be arranged with difficulty so as to essentially intersect each other. If this is not done, cables that extend between the lower and upper arms of the robot, upon rotation about said two axes, will be bent instead of twisted, which causes more wear on the cables. In addition, such a so-called offset between said axes entails a more restricted operating range for the robot than if it had not existed.

### SUMMARY OF THE INVENTION

It is the object of the present invention to provide an industrial robot of the kind described above, which in at least some respect is improved with respect to such prior art industrial robots.

This object is solved according to the invention by the provision of an industrial robot, in which said gear is a multistage gear transmission with parallel gear wheel axes and one of the gear wheels of the gear is secured with respect to the third axis, and said drive package with motor and gear for the third axis is enclosed in the upper arm of the robot.

By using such a multistage gear transmission in the actual drive package for rotation about said third axis, quite special advantages are obtained. A so-called zero offset between a possible fourth axis and the third axis may be achieved without any enhanced degree of complication. At the same time, there will be no problems to design the third axle to be hollow with a continuous hole with a relatively large cross section. Taken together, this makes it possible to achieve, by simple means, an increased working range for the robot as well as gentle load on cables upon movements of the upper arm of the robot relative to the lower arm thereof, with a possibility of arranging the cables in a concealed, and hence protected, manner with respect to the influence of the surroundings. Different embodiments of the invention will describe how this can be achieved concretely. By enclosing the drive package for the third axis in the upper arm of the robot, the robot may be made very compact with good protection for is internal parts. In addition, the very use of a multi-stage gear transmission at this location in a robot provides a possibility of taking measures for achieving elimination of play in the gear and hence a higher rigidity of the robot between the robot arms connected to the drive package in question. Such elimination of play is not possible, neither with a single-stage gear transmission, nor with a compact gear transmission. How this elimination of play can be achieved in practice is the object of one embodiment of the invention described below.

According to one embodiment of the invention, said gear wheel that is secured with respect to the third axis is arranged externally of and passed through by the third axis. In this way, said zero offset may be achieved if desirable and the third axle may simply be made hollow with a large cross section of said hole. This applies particularly if said gear wheel is the largest gear wheel of the gear, which anyway is the most suitable situation. This constitutes two additional embodiments of the invention.

According to another embodiment of the invention, the hole through said third axle has a cross section, the size of which considerably exceeds the size of the total cross section of the maximum number of conceivable cables for the movements of the robot that may extend from the lower arm past the transition between the lower arm and the upper arm and to the upper arm. In this way, the cables necessary for the movements of the robot may be protected against an external, possibly aggressive environment and against any damage due to movements of the robot.

According to another embodiment of the invention, the robot exhibits means for eliminating any play in the last stage of the gear in that said gear wheel, secured with respect to the third axis, and a penultimate gear wheel meshing therewith exhibit wedge-like teeth in the direction of their axes of rotation, and that means are arranged for spring-loaded influence of said penultimate gear wheel in the direction of said axes of rotation to mesh with said last gear wheel. In this way, it is ensured that the rotary motion of the upper arm relative to the lower arm may take place in a well-defined and even manner without any jumps, which is especially important if the robot is to carry out work that requires high precision. In addition, because of this wedge-like shape, the elimination of play with the resultant rigidity between the robot arms in question will be maintained over time, since the teeth are worn into an increasingly better fit, and this together with the spring loading provides for a very small play.

When using a drive package with a motor and a gear for rotating the upper arm relative to the lower arm about a fourth axis that is parallel to the longitudinal extent of the upper arm, this drive package and the drive package for the third axis may in such case advantageously be arranged is in one and the same space in the upper arm.

Thus, the drive package for the third axis is advantageously arranged in a said space that may be exposed by removing a housing, thus in a simple manner providing access to the parts of this drive package and any cables present there.

According to another embodiment of the invention, said gear for the third axis is a two-stage gear transmission, which has proved to be suitable for the gear ratios required, which normally implies that the gear should achieve a speed gear reduction between the motor and the third axle of at least 50 times, preferably 100 times.

According to yet another embodiment of the invention, also the first and second axles are hollow and provided with a drive package with the same type of multistage gear transmission as in the third axle, which means that cables for controlling the movements of the robot, that is, for supplying energy, usually electrical, as well as for trans-mission of signals, may be disposed to run in a protected manner through these axles.

According to still another embodiment of the invention, the lower arm is hollow, and cables for controlling the movement of the robot extend from the base to the upper arm inside the base, the frame and the lower arm through said three axles in a path that is sealed relative to the exterior, which renders the robot very well suited to work in environments that are aggressive in some way, that is, they could have a negative influence on the functioning of the internal parts of the robot, such as drive package, cabling and the like, provided they could reach into these parts. It could be a question of moisture or other special sub-stances in the surroundings. At the same time, this means that the robot may be rinsed and washed with water in a problem-free manner.

According to yet a further embodiment of the invention, the robot comprises so-called client cables, extending from the interior of the base to the frame through said first axle, that is, cables which are specific for the intended use of the robot, such as welding wires, and which do not belong to cables intended for controlling the movements of the robot. This is made possible because when using this type of gear, the axle in question may be simply made with a through-hole with a large cross section. It is especially advantageous to arrange a tube inside said first axle, said tube extending in the direction of said first axle and having a smaller outer diameter than the inner diameter of said axle, and to arrange the client cables in the tube and the cables intended for controlling the movements of the robot in the space between the tube and the inner wall of the axle to tightly mutually insulate these two types of cable. When, for example, using client cables for welding purposes, relatively strong currents will flow therethrough, and without such a tight insulation they may disturb the task that is to be solved by the other cables of the robot.

The invention also relates to a drive package for the third axis of an industrial robot according to the accompanying independent claims for such a drive package. The properties and the advantages of such a drive package should be adequately clear from the above description of the industrial robot according to the invention.

Further advantages and advantageous features of the invention will become clear from the following description and the other independent claims.

### BRIEF DESCRIPTION OF THE DRAWINGS

Embodiments of the invention, given as examples, will be described in the following with reference to the accompanying drawings, wherein:

FIG. 1 is a perspective view of an industrial robot according to the invention,

FIG. 2 is a perspective view, enlarged relative to FIG. 1, of the upper arm of the industrial robot, with a housing for an inner space in the upper arm being removed,

FIG. 3 is a perspective view of the actual drive package for the rotation of the upper arm relative to the lower arm about a said third axis,

FIG. 4 is a partly cut-away perspective view of said drive package and the third axle,

FIG. 5 is a perspective view of the upper arm of the industrial robot according to the invention, showing the side opposite to the side shown in FIG. 2,

FIG. 6 is a partly cut-away view of the industrial robot for illustrating the cable pulling inside it, and

FIG. 7 is a cut-away view of the lower part of the industrial robot according to one embodiment of the invention.

### DETAILED DESCRIPTION OF THE EMBODIMENTS OF THE INVENTION

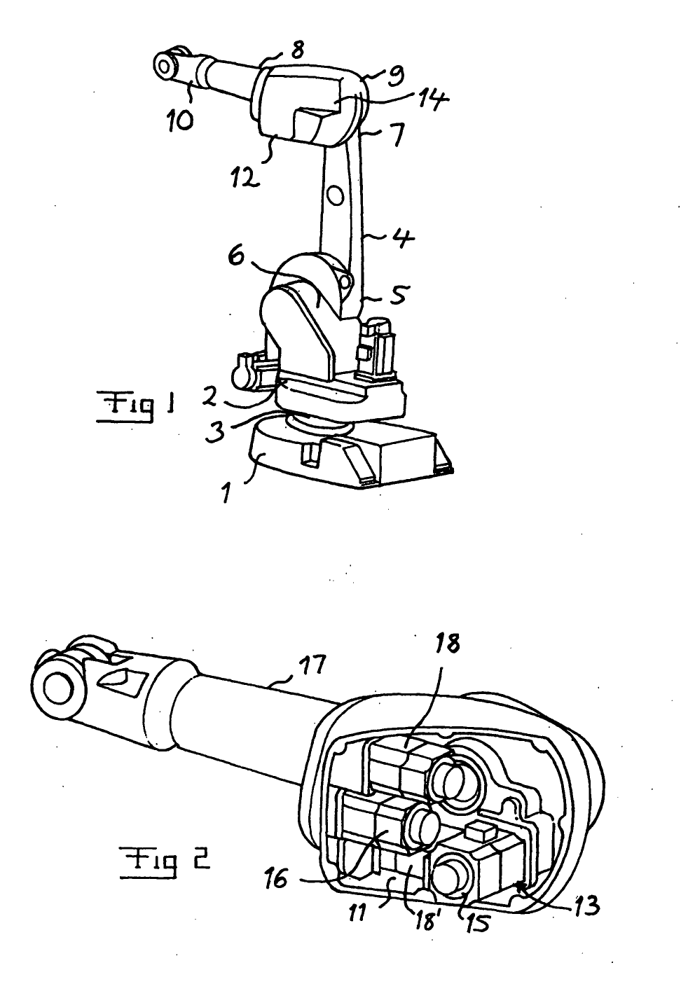

FIG. 1 illustrates an industrial robot according to the invention, said robot having a fixed base 1, the outer casing of which delimits an inner tight space for cables and electronics equipment intended both for transmission of electric power to the different motors of the robot and for signal transmission. A frame 2 is rotatably connected to the base around a vertical first axis 3 (the different axes are only schematically denoted in the figures). Further, one end 5 of the lower arm 4 is rotatably connected to the frame 2 about a horizontal second axis 6. Inside the frame 2, drive packages are arranged comprising a motor and a gear for rotation of the frame relative to the base about the first shaft as well as rotation of the lower arm relative to the frame about the second axis.

To the other end 7 of the lower arm, one end 9 of an upper arm 8 is rotatably connected about a horizontal axis that is parallel to the second axis. At the other end 10 of the upper arm, different types of equipment may be arranged; however, these are not relevant to the invention and will not therefore be described here.

Reference will now be made in parallel to FIGS. 2-4. In a space 11 inside the upper arm, which may be exposed by removing a housing 12, a drive package 13 for rotating the upper arm relative to the lower arm about said third axis 14 is arranged. In FIG. 2, the motor 15, an electric motor, of this drive package is shown. Also shown is a motor 16 included in a drive package for rotation of that part 17 of the upper arm which is extended past the space about a fourth axis, parallel to the longitudinal extent of the upper arm, and motors 18, 18′ for achieving rotary motions in the wrist of the robot at the end of the upper arm, which, however, will not be discussed in detail here.

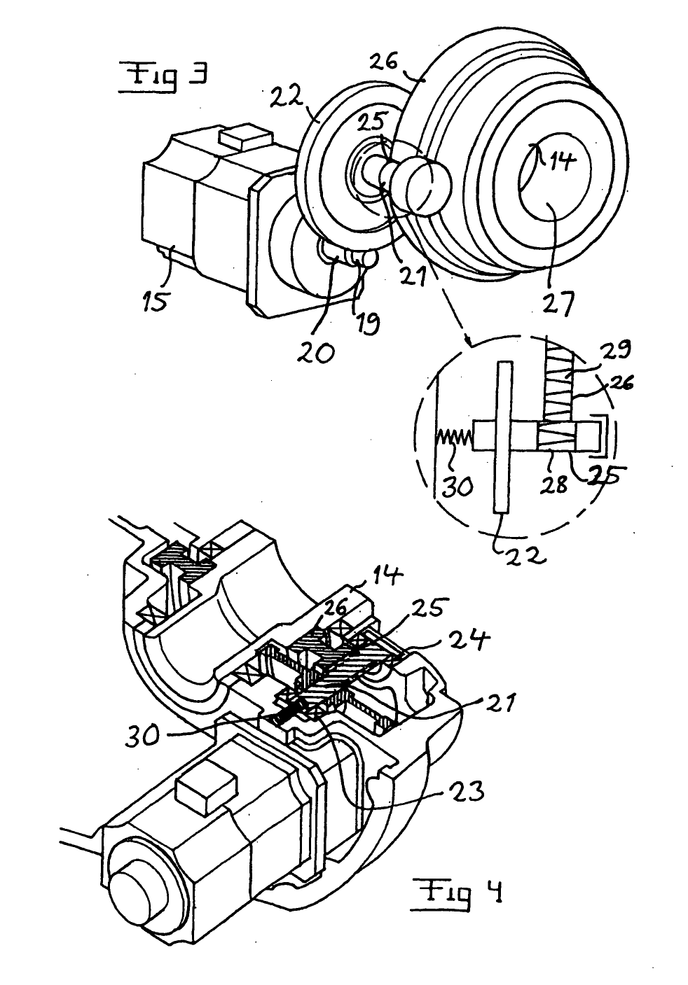

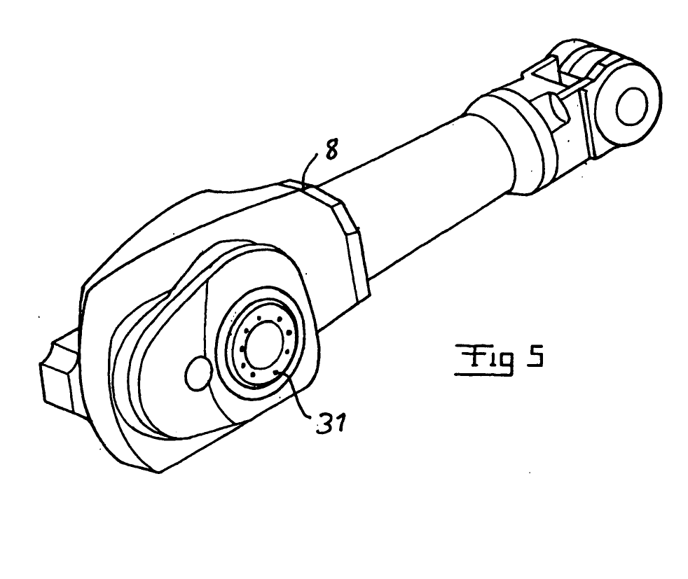

The composition of the gear between the motor 15 for the rotary motion about said third axis and the physical third axle 14 will be clear from FIGS. 3 and 4. It comprises a first stage in the form of a smaller gear wheel 20, arranged on the output shaft 19 of the motor, in mesh with a larger gear wheel 22 arranged-on a shaft 21. The shaft 21 is arranged to be rotatable about an axis parallel to the motor shaft in bearings 23, 24 (see FIG. 4).

The gear exhibits a second stage in the form of a small, so-called penultimate gear wheel 25 which is arranged on the shaft 21 and which is in gear mesh with a large, so-called last gear wheel 26, of the gear. The large gear wheel 26 is secured to the axle 14, which because of the large diameter of this gear wheel may be provided with a through-hole 27 with a relatively large cross section. By such a gear, a gear ratio of more than 100 is achieved without problems, that is, the speed of the output shaft of the motor is reduced down to an at least 100 times lower speed of the third axle.

The last stage of the gear is provided with automatic elimination of play in that the penultimate gear wheel 25 and the last gear 26 exhibit wedge-like teeth 28, 29 (see enlargement in FIG. 3) in the direction of their axes of rotation, and a spring 30 is arranged to load the shaft 21 and hence said penultimate gear wheel 25 in the direction of the axis of rotation of this shaft to mesh with the gear wheel 26.

The third axis and the fourth axis are arranged so as intersect each other, which is advantageous for the reasons stated above.

FIG. 5 shows the upper arm 8 and the stand part that tightly encloses the drive package on the third axle from the opposite direction, and the holes 31 for bolting the third axle to the lower arm are also shown.

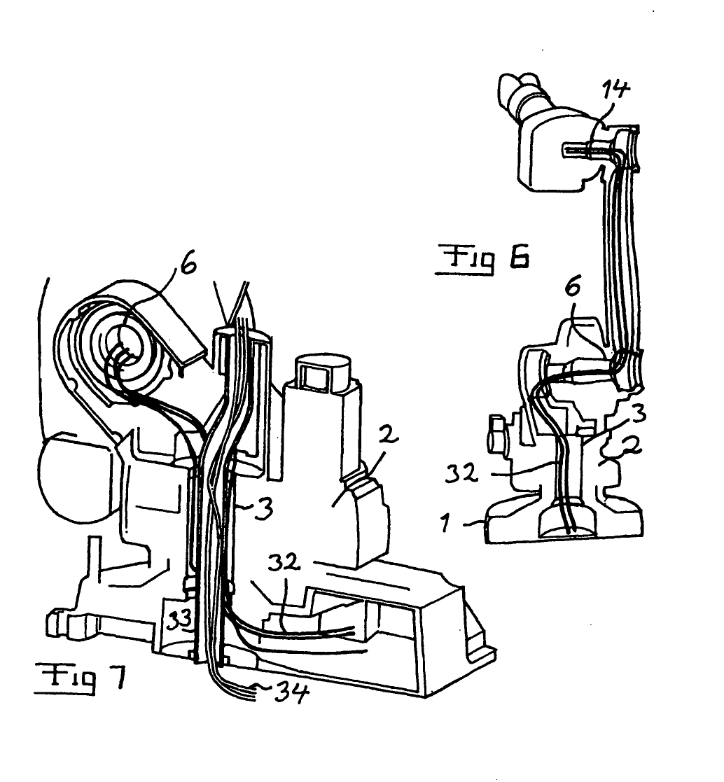

In the industrial robot according to the invention, also the first and second axles are hollow and provided with drive packages of the same type of multistage gear trans-missions as in the third axles, and the lower arm is hollow which makes it possible to pull cables 32 for controlling the movement of the robot from the base to the upper arm in a path that is sealed relative to the exterior, as is clear from FIG. 6. These “cables” may be of any kind, such as electric conductors, optical fibres, hoses for water and air, and the like. By the design of this type of gear, the cross section of the through-hole of the respective axle may also be made so large that the total cross section of these cables is considerably smaller and it will be possible, as shown in FIG. 7, to arrange a tube 33 inside the first axle for passing so-called client cables 34, such as welding wires, through this axle sealed and insulated from the cables 32 which are passed through the axle in the space between the tube and the inner wall of the shaft. These client cables 34 may then be passed on via another path than the cables 32, as illustrated in FIG. 7.

The invention is not, of course, in any way limited to the embodiments described above, but a plurality of possibilities of modifications thereof are obvious to a person skilled in the art, without this person therefore departing from the basic concept of the invention as defined in the accompanying claims.

For example, it would be possible for the gear in the drive package for the third axis to have more than two stages, for example three.

It is, of course, also possible that no so-called client cables are used or that such cables are drawn in some other way than what has been illustrated. Although it is advantageous to arrange the drive package for the third axis in the upper arm, it would be fully possible to arrange it in the lower arm.

1. An industrial robot, comprising:
a fixed base,
a frame rotatably connected to the fixed base about a first shaft,
a lower arm, having a first end rotatably connected to the frame about a second shaft,
an upper arm having a first end rotatably connected to a second end of the lower arm about a third shaft,
a first drive package comprising a motor and a gear between an output shaft of the motor and said third shaft is arranged in immediate proximity to the third shaft for rotation of the upper arm relative to the lower arm, wherein said gear is a multistage gear transmission with parallel gear wheel axes and one of the gear wheels of the gear is secured to the third shaft, wherein said drive package with motor and gear for the third shaft is enclosed in the upper arm of the robot, and
a second drive package comprising a motor and a gear for rotating the upper arm relative to the lower arm about a fourth shaft that is parallel to a longitudinal axis of the upper arm, wherein the first drive package and the second drive package are arranged in a space in the upper arm.

2. The industrial robot according to claim 1, wherein said gear wheel, which is secured to the third shaft, is arranged externally of and passed through by the third shaft.

3. The industrial robot according to claim 1 wherein said gear wheel, which is secured to the third shaft, is the larger gear wheel of the gear.

4. The industrial robot according to claim 1, wherein said third shaft (14) is hollow.

5. The industrial robot according to claim 4, wherein the hole through said third shaft has a cross section, the size of which considerably exceeds the size of the total cross section of the maximum number of conceivable cables for the movements of the robot, which may extend from the lower arm past the transition between the lower arm and the upper arm and to the upper arm.

6. The industrial robot according to claim 1, further comprising:
means for eliminating play in the last stage of the gear, wherein said gear wheel, which is secured to said third shaft, and a penultimate gear wheel meshing therewith comprise, in the directions of their axes of rotation, wedge-like teeth, and
members arranged for spring-loaded influence of said penultimate gear wheel in the direction of said axes of rotation to mesh with said last gear wheel.

7. The industrial robot according to claim 6, wherein said drive package for the third shaft is arranged in a space inside the stand of the robot and is capable of being exposed by removing a housing.

8. (canceled)

9. (canceled)

10. The industrial robot according to claim 1, wherein the drive package for the third shaft and a drive package with a motor and a gear for rotating the upper arm relative to the lower arm about a fourth shaft, which is parallel to the longitudinal extent of the upper arm, are arranged in such a way that the axes of rotation of the third and fourth shafts essentially intersect each other.

11. The industrial robot according to claim 1, wherein said gear for the third shaft is a two-stage gear transmission.

12. The industrial robot according to claim 1, wherein the gear ratio of said gear in the third shaft corresponds to a speed gear reduction of at least 50 times.

13. The industrial robot according to claim 4, wherein the first and second shafts are hollow and provided with drive packages comprising multistage gear transmissions.

14. The industrial robot according to claim 13, wherein the lower arm is hollow, and wherein cables for controlling the movements of the robot extend from the base to the upper arm inside the base, the frame and the lower arm through said three shafts in a path that is sealed relative to the exterior.

15. The industrial robot according to claim 13, further comprising:
client cables, extending from the interior of the base to the frame through said first shaft, wherein the client cables are specific for an intended use of the robot, and which do not belong to cables intended for controlling the movements of the robot.

16. The industrial robot according to claim 15, further comprising:
a tube, extending inside said first shaft in the direction thereof, with a smaller outer diameter than the inner diameter of said shaft, and wherein said client cables are arranged in the tube and the cables intended for controlling the movements of the robot in the space between the tube and the inner wall of the shaft to tightly separate these two types of cable.

17. A drive package for a third shaft of an industrial robot with a fixed base, a frame rotatably connected to the fixed base about a first shaft, a lower arm, one end of which is rotatably connected to the frame about a second shaft, and an upper arm, one end of which is rotatably connected to the other end of the lower arm about a third shaft, the drive package comprising:
a motor and
a gear arranged to be mounted between the output shaft of the motor and the third shaft in immediate proximity to the third shaft, wherein the gear is a multistage gear transmission with parallel gear-wheel axes and wherein one of the gear wheels of the gear is secured to the third shaft.

18. The industrial robot according to claim 12, wherein the gear ratio of said gear in the third shaft corresponds to a speed gear reduction of at least 100 times.

19. The industrial robot according to claim 15, wherein the client cables comprise welding wires.
